(19) United States
(12) Patent Application Publication
(10) Pub. No.: US 2025/0026599 A1
(43) Pub. Date: Jan. 23, 2025

(54) IMAGE FORMING SYSTEM

(71) Applicant: FUJIFILM BUSINESS INNOVATION CORP., Tokyo (JP)

(72) Inventor: Yutaka KIUCHI, Kanagawa (JP)

(73) Assignee: FUJIFILM BUSINESS INNOVATION CORP., Tokyo (JP)

(21) Appl. No.: 18/581,943

(22) Filed: Feb. 20, 2024

(30) Foreign Application Priority Data
Jul. 20, 2023 (JP) 2023-118690

(51) Int. Cl. B65H 20/16

(52) U.S. Cl. CPC B65H 20/16; B65H 2301/41722; B65H 2551/21

(57) ABSTRACT

An image forming system includes: a transport device including a loop member that turns and that includes multiple grip units, the transport device transporting a medium that is gripped by the multiple grip units as the loop member turns; a formation device that forms an image on the medium that is transported by the transport device; and a processor configured to: cause the formation device to start image formation on a medium that is gripped by a specific grip unit of the multiple grip units in an association mode.

### CROSS-REFERENCE TO RELATED APPLICATIONS

This application is based on and claims priority under 35 USC 119 from Japanese Patent Application No. 2023-118690 filed Jul. 20, 2023.

### BACKGROUND

### (i) Technical Field

The present disclosure relates to an image forming system.

### (ii) Related Art

For example, Japanese Unexamined Patent Application Publication No. 2023-031856 discloses an image forming apparatus including a cylinder member including a cylinder body having a substantially circular cross section and a dent portion, a sheet member wrapped around the cylinder body and including a metal layer that is in contact with the cylinder body and an outer layer, a first attachment member provided in the metal layer at a first end portion of the sheet member and removably attached to the dent portion at a first side of the dent portion, a second attachment member provided on an end portion of the metal layer at a second end portion of the sheet member and removably attached to the dent portion at a second side of the dent portion, a tension-applying screw that pulls the second attachment member in a depth direction of the dent portion to apply tension to the metal layer, a positioning pin that is included in the second attachment member, and a positioning hole in which the positioning pin that is formed at an end portion of the metal layer is fitted, and an image forming unit that forms an image on a recording medium that is transported by the cylinder member.

### SUMMARY

Aspects of non-limiting embodiments of the present disclosure relate to an image forming system that includes multiple grip units and that is capable of associating a medium on which an image is formed with a grip unit that grips the medium.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including: a transport device including a loop member that turns and that includes a plurality of grip units, the transport device transporting a medium that is gripped by the plurality of grip units as the loop member turns; a formation device that forms an image on the medium that is transported by the transport device; and a processor configured to: cause the formation device to start image formation on a medium that is gripped by a specific grip unit of the plurality of grip units in an association mode.

### BRIEF DESCRIPTION OF THE DRAWINGS

Exemplary embodiments of the present disclosure will be described in detail based on the following figures, wherein:

FIG. 1 is a front sectional view for describing an image forming apparatus according to a first exemplary embodiment of the present disclosure;

FIG. 2 is a front sectional view for describing the structure of an image forming unit and transport units according to the first exemplary embodiment of the present disclosure;

FIG. 3 is a perspective view of a chain gripper according to the first exemplary embodiment of the present disclosure;

FIG. 4 illustrates the structure of a controller according to the first exemplary embodiment of the present disclosure;

FIG. 5 is a flowchart illustrating a procedure for association according to the first exemplary embodiment of the present disclosure;

FIG. 6 illustrates recording media that are acquired in accordance with the procedure for association according to the first exemplary embodiment of the present disclosure;

FIG. 7 is a flowchart illustrating a procedure for dealing with failure according to the first exemplary embodiment of the present disclosure;

FIG. 8 is a flowchart illustrating a procedure for association according to a modification to the first exemplary embodiment of the present disclosure;

FIG. 9 illustrates a screen that is displayed on a display unit in accordance with the procedure for association according to the modification to the first exemplary embodiment of the present disclosure;

FIG. 10 is a flowchart illustrating a procedure for association according to a second exemplary embodiment of the present disclosure; and

FIG. 11 is a flowchart illustrating a procedure for dealing with failure according to the second exemplary embodiment of the present disclosure.

### DETAILED DESCRIPTION

Exemplary embodiments of the present disclosure will hereinafter be described by way of example with reference to the drawings. In the drawings, like or equivalent components and parts are designated by using like reference characters. Ratios of dimensions in the drawings are exaggerated for convenience of description and differ from actual ratios in some cases. In the case where it is necessary to distinguish between one direction and the other direction of vertical directions of apparatus, width directions of apparatus, and depth directions of apparatus, an upward direction is referred to as a +H direction, a downward direction is referred to as a −H direction, a right-hand direction is referred to as a +W direction, a left-hand direction is referred to as a −W direction, a backward direction is referred to as a −D direction, and a forward direction is referred to as a +D direction when the front of an image forming apparatus 10 is viewed.

In the following description, a user represents a person who creates a printed material by using an image forming apparatus, and an operator represents a person who repairs the image forming apparatus. The user and the operator are not limited by the number thereof and may double with each other in some cases.

### First Exemplary Embodiment

### Image Forming Apparatus

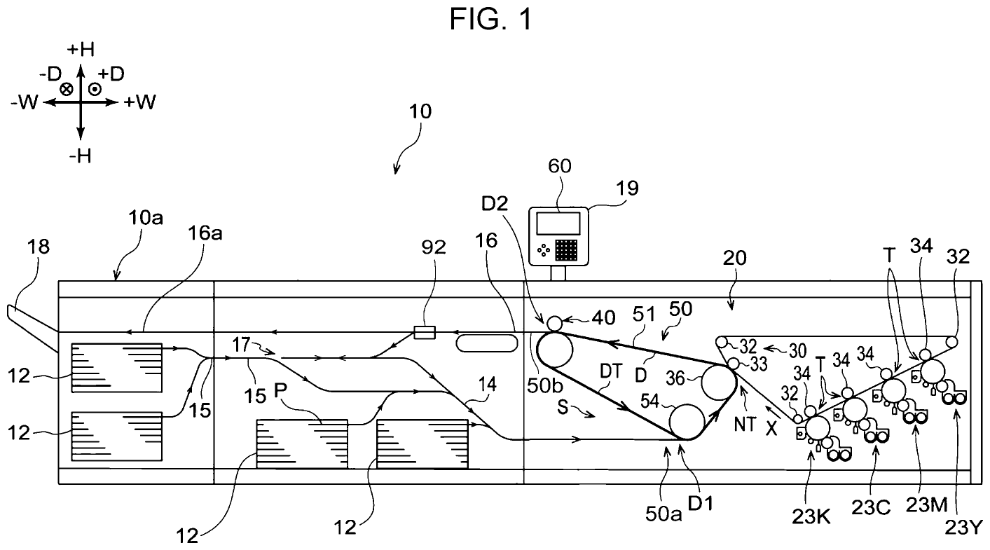

The image forming apparatus 10 according to the present exemplary embodiment is an example of an image forming system according to the present disclosure and is an electrophotographic image forming apparatus that forms a toner image on a recording medium P that is an example of a medium. As illustrated in FIG. 1, the image forming apparatus 10 includes container units 12, a first supply portion 14, a second supply portion 15, an image forming unit 20 that is an example of a formation device according to the present disclosure, a discharge portion 16, a branch portion 17, and a discharge destination portion 18. The image forming apparatus 10 includes an imaging device 92 that is an example of a measurement device according to the present disclosure, a controller 19 that controls components, a chain gripper 50 that is an example of a transport device according to the present disclosure, and a fixing unit 40 that fixes the toner image that is formed on the recording medium to the recording medium. The image forming apparatus 10 includes a first transport unit 50a and a second transport unit 50b.

The image forming apparatus 10 further includes a housing 10a that contains components. The housing 10a contains the image forming unit 20. The housing 10a contains the first supply portion 14, the second supply portion 15, the discharge portion 16, and the branch portion 17. The housing 10a will be described in detail later. An example of the recording medium P according to the present exemplary embodiment is a sheet member such as paper.

### Housing

The housing 10a includes a frame that has a rectangular cuboid shape and a wall portion that covers surfaces of the frame. Parts of the wall portion of the housing 10a that face in the width direction of apparatus and in the depth direction of apparatus are referred to as side walls. A part of the wall portion of the housing 10a that covers a plane that faces in the −H direction is referred to as a bottom wall.

The housing 10a includes multiple leg portions (not illustrated) that enable height in the vertical direction of apparatus to be freely increased or decreased and that are at the bottom of the frame. The housing 10a has a function of adjusting the position in the vertical direction of apparatus by expanding or shrinking the leg portions in the vertical direction of apparatus.

### Container Unit

The container units 12 have a function of containing the recording media P. As for the image forming apparatus 10, the number of the container units 12 is four. The recording media P are selectively fed from the four container units 12. According to the present exemplary embodiment, two container units 12 are arranged in the vertical direction of apparatus and are disposed in the housing 10a. The other two container units 12 are arranged in the width direction of apparatus and are disposed in the housing 10a.

### First Supply Portion

The first supply portion 14 has a function of transporting the recording media P that are contained in the container units 12 in the housing 10a by using multiple transport rollers (not illustrated) that are disposed in the housing 10a and supplying the recording media P to the image forming unit 20 in the housing 10a.

### Second Supply Portion

The second supply portion 15 has a function of transporting the recording media P that are contained in the container units 12 in the housing 10a by using the housing 10a and multiple transport rollers (not illustrated) that are disposed in the housing 10a, merging with the first supply portion 14, and supplying the recording media P toward the image forming unit 20 in the housing 10a. The second supply portion 15 extends between the branch portion 17 described later and the container units 12 in the vertical direction of apparatus and merges with the first supply portion 14.

### Image Forming Unit

The image forming unit 20 is disposed in the housing 10a and has a function of forming images on the recording media P by using an electrophotographic system. The image forming unit 20 includes photoconductor units 23 that form toner images and a transfer device 30 that transfers the toner images that are formed by the photoconductor units 23 to the recording media P.

The first transport unit 50a and the second transport unit 50b include the multiple transport rollers not illustrated. The first transport unit 50a is connected to the first supply portion 14 and transports the recording media P that are supplied from the first supply portion 14 in the housing 10a toward a reception position D1 on the chain gripper 50 in the width direction of apparatus (the horizontal direction). The second transport unit 50b is connected to the discharge portion 16 and transports the recording media P to which the toner images are fixed by the fixing unit 40 toward the discharge portion 16 in the housing 10a in the width direction of apparatus (the horizontal direction).

The multiple photoconductor units 23 form the toner images in respective colors. According to the present exemplary embodiment, the photoconductor units 23 for four colors of yellow (Y), magenta (M), cyan (C), and black (K) are included. FIG. 1 illustrates Y, M, C, and K that represent components associated with the colors described above. In the case where the colors (Y, M, C, and K) are not particularly distinguished, the end of an alphabet is omitted for description.

### Photoconductor Unit

The photoconductor units 23Y, 23M, 23C, and 23K basically have the same structure except for toner that is used.

As illustrated in FIG. 1, the photoconductor units 23Y, 23M, 23C, and 23K are arranged along an inclining portion of a transfer belt 31 (described in detail later) of the transfer device 30.

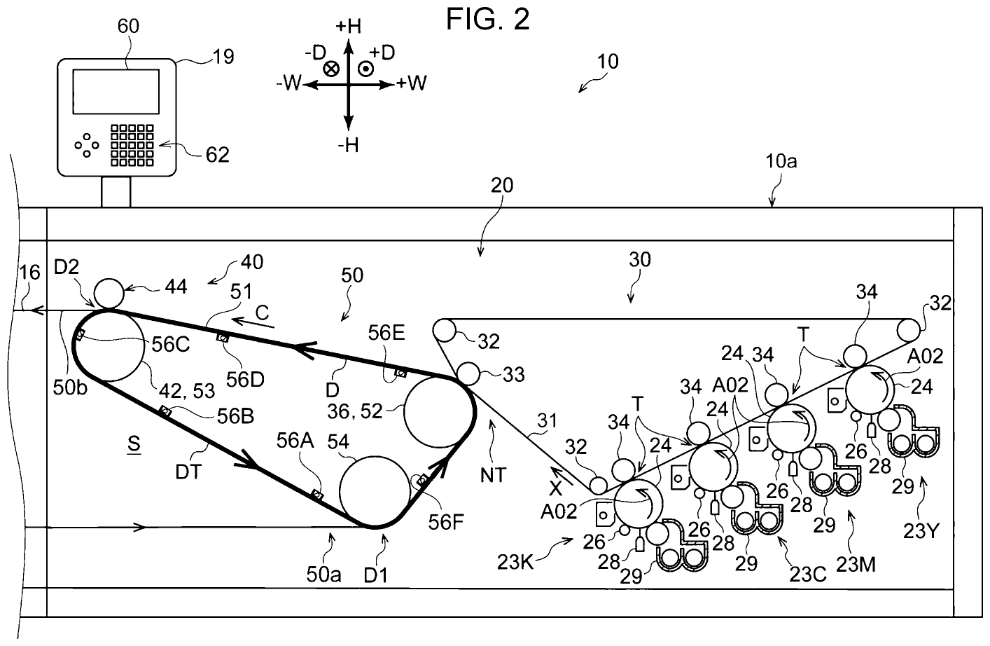

As illustrated in FIG. 2, each of the photoconductor units 23 includes a photoconductor drum 24 that rotates in the direction of an arrow A02 in the figure and a charger 26 that charges the photoconductor drum 24. Each of the photoconductor units 23 further includes an exposure device 28 that exposes the photoconductor drum 24 charged by the charger 26 to light and that forms an electrostatic latent image, and a developing device 29 that develops the electrostatic latent image by using the toner and that forms the toner image.

### Transfer Device

The transfer device 30 has a function of first-transferring the toner images in the respective colors on the photoconductor drums 24 such that the toner images are superposed on an intermediate transfer body and second-transferring the superposed toner images to the recording media P. Specifically, as illustrated in FIG. 2, the transfer device 30 includes the transfer belt 31 that serves as the intermediate transfer body, multiple rollers 32, first transfer rollers 34, a second transfer roller 33, and a transfer body 36.

The transfer belt 31 has no ends and is wound around the multiple rollers 32 so as to have a posture in the form of a substantially inverted triangle. At least one of the multiple rollers 32 is rotated, and consequently, the transfer belt 31 turns in the direction of an arrow X.

The first transfer rollers 34 are roll members that are disposed opposite the photoconductor drums 24 for the respective colors with the transfer belt 31 interposed therebetween. The first transfer rollers 34 have a function of transferring the toner images that are formed on the photoconductor drums 24 to the transfer belt 31 at first transfer positions T between the photoconductor drums 24 and the first transfer rollers 34.

The second transfer roller 33 is a roll member that is disposed inside the transfer belt 31 between the roller 32 in the −W direction and the roller 32 in the −H direction among the rollers 32 around which the transfer belt 31 is wound in the form of a substantially inverted triangle and is in contact with the transfer belt 31. The transfer body 36 is a roll member that is disposed opposite the second transfer roller 33 with the transfer belt 31 interposed therebetween and that extends in the depth direction of apparatus. The second transfer roller 33 and the transfer body 36 have a function of transferring the toner images that are transferred to the transfer belt 31 to the recording media P at a second transfer position NT between the transfer belt 31 and the transfer body 36.

### Chain Gripper

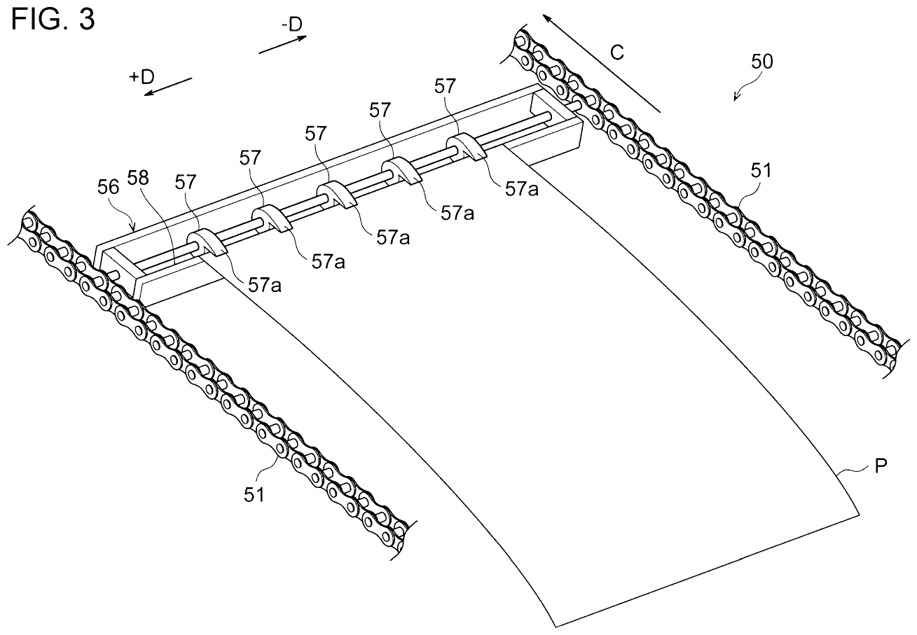

As illustrated in FIG. 3, the chain gripper 50 includes two chains 51, grip units 56 that hold leading edges of the recording media P, and sprockets 52, 53, and 54. The chains 51 are examples of a loop member. The multiple grip units 56 are disposed at an interval in a direction in which the chains 51 turn.

The two chains 51 are separated from each other in the depth direction of apparatus. The chains 51 have no ends. The two chains 51 are wound around two sprockets 52 that are disposed on both sides in the longitudinal direction (the axial direction) of the transfer body 36 and that have an axial direction that coincides with the longitudinal direction. The two chains 51 are wound around two sprockets 53 that are disposed on both sides in the longitudinal direction (the axial direction) of a pressure roller 42 described later and that have an axial direction that coincides with the longitudinal direction. As illustrated in FIG. 2, the two chains 51 are wound around two sprockets 54 that are disposed at an interval in the depth direction of apparatus.

The sprockets 53 that are disposed on both sides in the longitudinal direction of the pressure roller 42 are disposed at positions away from the sprockets 52 that are disposed on both sides in the longitudinal direction of the transfer body 36 in the −W direction and in the +H direction.

The two sprockets 54 are disposed below the sprockets 52 and 53 at positions away from the sprockets 52 in the −W direction and away from the sprockets 53 in the +W direction when viewed in the depth direction of apparatus. A transport roller (not illustrated) that is coaxial with the two sprockets 54 is disposed between the two sprockets 54.

According to the present exemplary embodiment, as illustrated in FIG. 2, six grip units 56 of a first grip unit 56A to a sixth grip unit 56F are provided as examples. As illustrated in FIG. 2, the first grip unit 56A to the sixth grip unit 56F are mounted in order in a turning direction. The controller 19 described later grasps the positions of the first grip unit 56A to the sixth grip unit 56F in the direction in which the chain gripper 50 turns. A method in which the controller 19 grasps the positions in the turning direction may be any method, and an example thereof is that a mark that is read by a sensor, not illustrated, is formed on the first grip unit 56A, the sensor reads the mark, and consequently, the position of the first grip unit 56A in the turning direction is recognized. In the following description, the first grip unit 56A to the sixth grip unit 56F are simply referred to as the grip units 56 in the case where the first grip unit 56A to the sixth grip unit 56F are not particularly distinguished. The first grip unit 56A to the sixth grip unit 56F are disposed at a substantially regular interval in the turning direction.

Each of the grip units 56 extends in the depth direction of apparatus and includes multiple grippers 57. Both sides of each of the grip units 56 in the depth direction of apparatus are mounted on the two chains 51.

The grippers 57 are mounted on the grip units 56 at a predetermined interval in the depth direction of apparatus. The grippers 57 have a function of holding the leading edges of the recording media P. Specifically, each of the grippers 57 includes a pawl 57a. Each of the grip units 56 includes a contact portion 58 that comes into contact with the pawl 57a.

The grippers 57 hold the recording media P by gripping the leading edges of the recording media P between the pawls 57a and the contact portions 58. As for the grippers 57, for example, springs press the pawls 57a against the contact portions 58, and the pawls 57a are brought into contact with and separated from the contact portions 58 due to, for example, a cam action.

With this structure, rotational force is transmitted to any one of the multiple sprockets 52, 53, and 54 illustrated in FIG. 2, and consequently, the two chains 51 turn in the direction of an arrow in the figure so as to move in a direction from the sprockets 52 toward the sprockets 53.

When the grip units 56 that are mounted on the two chains 51 reach the reception position D1 at the lower ends of the sprockets 54, the grippers 57 of the grip units 56 grip the leading edges of the recording media P that are transported along the first supply portion 14 and the first transport unit 50a and hold and receive the recording media P. The chains 51 that turn in the direction of an arrow C transport the recording media P that are held by the grip units 56 to the second transfer position NT, and consequently, the toner images are transferred to the recording media P. The chains 51 that turn transport the recording media P from the second transfer position NT to the fixing unit 40, and consequently, the toner images are fixed to the recording media P. The grip units 56 release the leading edges of the recording media P that are held at a feed position D2 at which the leading edges of the recording media P pass through the fixing unit 40, and the chain gripper 50 feeds the recording media P to the second transport unit 50b and the discharge portion 16.

### Fixing Unit

As illustrated in FIG. 2, the fixing unit 40 is disposed downstream of the transfer body 36 in a direction in which the recording media P are transported.

The fixing unit 40 includes a heat roller 44 that comes into contact with the recording media P that are transported and that heats the recording media P and the pressure roller 42 that presses the recording media P toward the heat roller 44.

The heat roller 44 is a roll member that comes into contact with upper surfaces of the recording media P that are transported and that extends in the depth direction of apparatus with the axial direction coinciding with the depth direction of apparatus. Shaft portions that extend in the depth direction of apparatus are formed on both sides of the heat roller 44 in the depth direction of apparatus, and support members support the shaft portions. The heat roller 44 is heated by a driven roller that includes a heater not illustrated.

The pressure roller 42 is a roll member that extends in the depth direction of apparatus with the axial direction coinciding with the depth direction of apparatus and that comes into contact with lower surfaces of the recording media P that are transported opposite the heat roller 44 with the recording media P that are transported interposed therebetween. With this structure, the pressure roller 42 presses the recording media P toward the heat roller 44. Rotational force is transmitted from a drive member not illustrated to the pressure roller 42, and the pressure roller 42 rotates. The pressure roller 42 that rotates causes the heat roller 44 to rotate. The heat roller 44 and the pressure roller 42 interpose the recording media P to which the toner images are transferred therebetween and transport the recording media P, and consequently, the toner images are heated and fixed to the recording media P.

### Discharge Portion

The discharge portion 16 has a function of discharging the recording media P that are transported after the toner images are fixed by the fixing unit 40 via a discharge port that is provided in a side surface of the housing 10a. According to the present exemplary embodiment, the recording media P that are transported after the toner images are fixed by the fixing unit 40 are received by an extension discharge portion 16a that is included in the housing 10a and are discharged onto the discharge destination portion 18 that is provided outside the housing 10a.

### Branch Portion

The branch portion 17 branches from the discharge portion 16 in the housing 10a and has a function of inverting the leading edges and trailing edges of the recording media P that are transported to the branch portion 17 and feeding the recording media P to the first supply portion 14. Specifically, the branch portion 17 has a function of changing the direction in which the recording media P that are transported from the discharge portion 16 to the branch portion 17 into a direction opposite the transport direction of the discharge portion 16 downstream of the fixing unit 40.

The branch portion 17 is disposed above the container units 12 in the housing 10a. The recording media P that are transported to the branch portion 17 and that are fed to the first supply portion 14 are transported to the second transfer position NT with the recording media P turned over unlike a state before the recording media P are transported to the branch portion 17 because the leading edges and trailing edges of the recording media P are inverted. That is, as for the recording media P that are transported to the branch portion 17, that are fed to the first supply portion 14, and that are transported to the second transfer position NT, the toner images are transferred on a surface (a back surface) that differs from a surface (a front surface) on which the toner images are formed before the recording media P are transported to the branch portion 17.

### Imaging Device

The imaging device 92 is provided at the branch portion 17 and is a so-called inline sensor that images the recording media P that are transported after the toner images are fixed by the fixing unit 40. The imaging device 92 includes multiple measurement sensors and transmits, as the result of measurement, the image data of the recording media P that are imaged to the controller 19.

### Controller

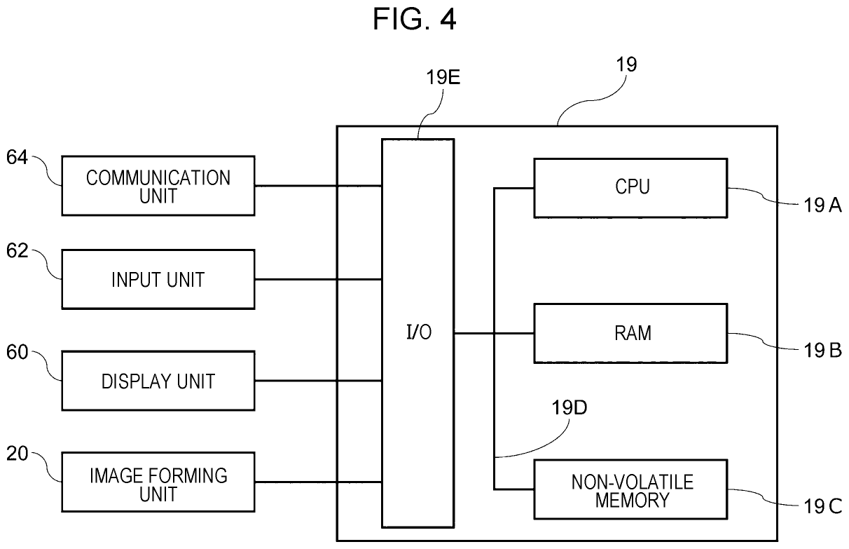

As illustrated in FIG. 4, the controller 19 includes a central processing unit (CPU) 19A that is an example of a processor and a random access memory (RAM) 19B that is used as a temporary work area for the CPU 19A. The controller includes a non-volatile memory 19C that stores a control program that causes the controller 19 to function and an input-output interface (I/O) 19E. The CPU 19A, the RAM 19B, the non-volatile memory 19C, and the I/O 19E are connected to each other via a bus 19D.

A dedicated processor that performs processing and a memory are thus assigned to the controller 19. The CPU 19A reads the control program in the non-volatile memory 19C and implements control on the entire image forming apparatus 10 for which the controller 19 takes the responsibility.

The non-volatile memory 19C is an example of a storage device in which stored information is maintained even when power to be supplied is cut off, and a semiconductor memory, for example, is used but a hard disk may be used. In the non-volatile memory 19C, an association mode described later and a program that causes the CPU 19A to operate in the association mode are stored.

A communication unit 64, an input unit 62, a display unit 60, and the image forming unit 20 are connected to the I/O 19E.

The communication unit 64 is connected to a communication line and has a communication protocol for transmitting and receiving data to and from an external device (not illustrated) that is connected to the communication line. The communication unit 64 establishes data communication with the external device in accordance with an instruction from the CPU 19A of the controller 19.

The input unit 62 is a device that receives an instruction from the user and that reports the received instruction to the CPU 19A of the controller 19, and a button, a touch screen, and a pointing device, for example, are used as illustrated in FIG. 2.

The display unit 60 is an example of a display device that displays information that is processed by the image forming apparatus 10, and a liquid-crystal display or an organic electro luminescence (EL) display, for example, are used. The display unit 60 displays information in accordance with an instruction from the CPU 19A of the controller 19.

The components that are connected to the I/O 19E are examples, and a component suitable for the function of the image forming apparatus 10 is connected thereto. The components are units that perform processing under the control of the processor such as the CPU 19A and the RAM 19B.

In some cases, failure occurs, for example, the grip units 56 have nonuniform force by which the grippers 57 grip the recording media P, or a timing with which a specific gripper 57 grips the recording medium P differs from a timing with which another gripper 57 grips the recording medium P. In the case where the grip units 56 have such failure, the recording media P are griped by the grip units 56 at the reception position D1 so as to bend, and the toner images that are formed by the image forming unit 20 are transferred to the recording media P at positions that differ from expected positions. The recording media P to which the toner images are transferred at the positions that differ therefrom are transported to the fixing unit 40, and the toner images are fixed so as to be distorted.

As for the image forming apparatus 10 according to the present exemplary embodiment, the user operates the controller 19, and the CPU 19A reads the program that is stored in the non-volatile memory 19C and performs the association mode described later. In the following description, an N-th recording medium P is an N-th fed recording medium P among the multiple recording media P that are fed from the container units 12.

### Association Mode

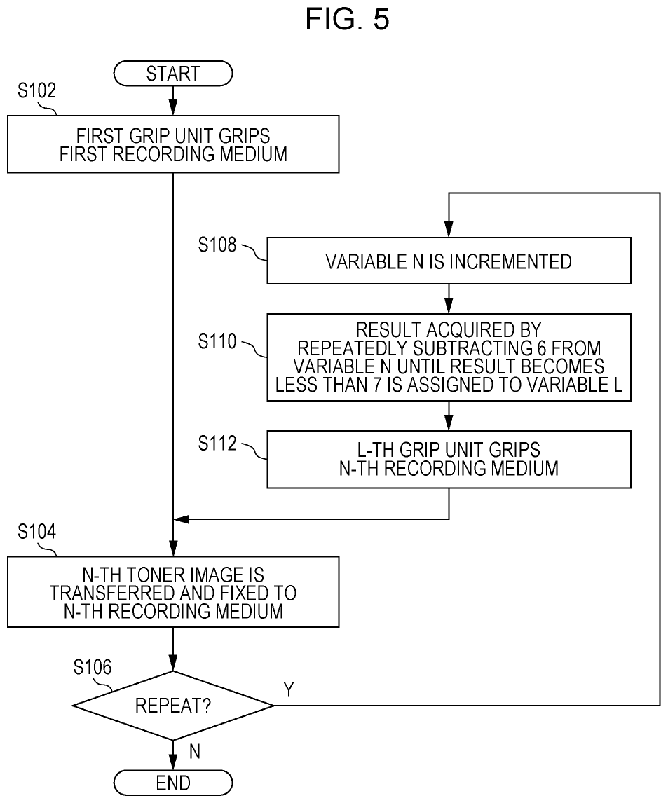

The operation of the CPU 19A of the controller 19 in the association mode according to the present exemplary embodiment will now be described with reference to FIG. 5 to FIG. 7 appropriately. In the association mode, the CPU 19A performs a procedure for association and a procedure for dealing with failure. In the association mode, the recording media P the number of which is larger than the number (six according to the present exemplary embodiment) of the grip units 56 are prepared in the container units 12 in advance. The CPU 19A performs a flow of processing illustrated in FIG. 5.

The toner images according to the present exemplary embodiment include an image that contains a symbol, a picture, a character, and/or a character string. According to the present exemplary embodiment, an N-th image represents a toner image in which a numeral that corresponds to the value of N is contained. According to the present exemplary embodiment, a numeral that corresponds to a variable N is transferred as a toner image to the N-th recording medium P.

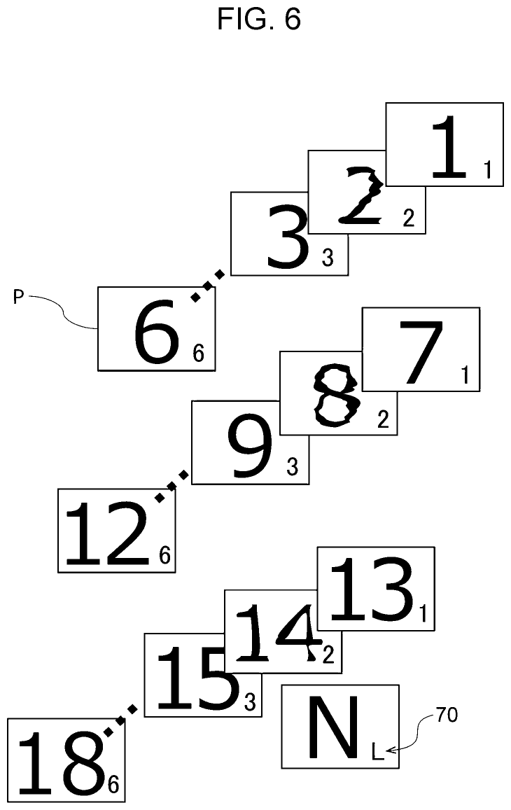

According to the present exemplary embodiment, identification information 70 illustrated in FIG. 6 is added at a corner in the N-th image. According to the present exemplary embodiment, an example of the identification information 70 is a numeral for distinguishing among the first grip unit 56A to the sixth grip unit 56F. For example, a numeral of “1” in the identification information 70 corresponds to the first grip unit 56A, and a numeral of “2” corresponds to the second grip unit 56B. Similarly, numerals of “3” to “6” correspond to the third grip unit 56C to the sixth grip unit 56F.

At a step S102, the CPU 19A causes the first grip unit 56A to grip a first recording medium P. The CPU 19A prepares the variable N and a variable L in the RAM 19B. The variable N and the variable L are integer variables. The CPU 19A assigns 1 to the variable N and the variable L and initializes the variable N. The CPU 19A proceeds to a step S104.

At the step S102, the CPU 19A causes the first grip unit 56A to grip the first recording medium P. In other words, the CPU 19A causes the image forming unit 20 to start image formation on the recording medium P that is gripped by a specific grip unit 56 among the multiple grip units 56. The CPU 19A proceeds to the step S104.

Subsequently, the CPU 19A causes the image forming unit 20 to form the N-th image that contains the identification information 70 that corresponds to the value of the variable N at the step S104. The N-th image that contains the identification information 70 is transferred to the recording medium P that corresponds to the value of the variable N at the time of the step S104. For example, in the case where the variable N is 1, the CPU 19A causes a first image to be formed and causes the first image to be transferred to the first recording medium P. For example, in the case where the variable N is 2, the CPU 19A causes a second image to be formed and causes the second image to be transferred to a second recording medium P. For example, in the case where the variable N is 6, the CPU 19A causes a sixth image to be formed and to be transferred to a sixth recording medium P. For example, in the case where the variable N is 7, the CPU 19A causes a seventh image to be formed and to be transferred to a seventh recording medium P. For example, in the case where the variable N is 8, the CPU 19A causes an eighth image to be formed and to be transferred to an eighth recording medium P.

The identification information 70 is a numeral that corresponds to the value of the variable L at the time of the step S104. That is, in the case where the variable L is 1, a numeral “1” is contained as the identification information 70 in the N-th image. In the case where the variable L is 2, a numeral of “2” is contained as the identification information 70 in the N-th image. The N-th recording medium P is transported to the L-th grip unit 56 as described above, and accordingly, the numeral that corresponds to the variable L is used to identify the multiple grip units 56 according to the present exemplary embodiment. In other words, the CPU 19A causes the recording media P into which the identification information 70 is added are transported to the multiple grip units 56 that are associated with the identification information 70. The recording media P to which the toner images are transferred and are fixed by the fixing unit 40 are discharged via the discharge portion 16 of the image forming apparatus 10. The CPU 19A proceeds to a step S106.

Subsequently, at the step S106, the CPU 19A compares the value of N with a predetermined value. In the case where the value of N is smaller than the predetermined value, at the step S106, positive determination is made, and the CPU 19A proceeds to a step S108. In the case where the value of N is larger than the predetermined value, at the step S106, negative determination is made, and the flow of processing ends.

Subsequently, at the step S108, the CPU 19A increments the variable N (increases the value of the variable N by 1). The CPU 19A proceeds to a step S110.

Subsequently, at the step S110, the CPU 19A assigns the value of a result acquired by repeatedly subtracting 6 from the value of the variable N until the result becomes less than 7 to the variable L. For example, in the case where the variable N is 1, 1 is assigned to the variable L. In the case where the variable N is 6, 6 is assigned to the variable L. In the case where the variable N is 8, 2 acquired by subtracting 6 from 8 is assigned to the variable L. The CPU 19A proceeds to a step S112.

Subsequently, at the step S112, the CPU 19A causes the grip unit 56 that corresponds to the value of the variable L to grip the N-th recording medium P that is transported from the container units 12. For example, in the case where the variable N is 2, the CPU 19A causes the second grip unit 56B to grip the second recording medium P. For example, in the case where the variable N is 6, the CPU 19A causes the sixth grip unit 56F to grip the sixth recording medium P. For example, in the case where the variable N is 7, the CPU 19A causes the first grip unit 56A to grip the seventh recording medium P. In the case where the variable N is 8, the CPU 19A causes the second grip unit 56B to grip the eighth recording medium P. The CPU 19A proceeds to the step S104.

In the case where the flow of processing described above ends, as illustrated in FIG. 6, the user visually compares the N-th images that are formed on the first to N-th recording media P that are discharged from the image forming apparatus 10 and checks whether the N-th images that are formed on the recording media P are distorted. Leaders (symbols “ . . . ”) in FIG. 6 represent omission. According to the present exemplary embodiment, for example, as illustrated in FIG. 6, toner images (the second image, the eighth image, and a fourteenth image) of “2”, “8”, and “14” are fixed so as to be distorted, and accordingly, the user determines that the second grip unit 56B that transports the recording media P has failure. In the case where the user thus determines that any one of the grip units 56 has failure, based on the images that are fixed to the recording media P and the identification information 70, the user checks the identification information 70 that is added into the images and consequently identifies the grip unit 56 that has failure.

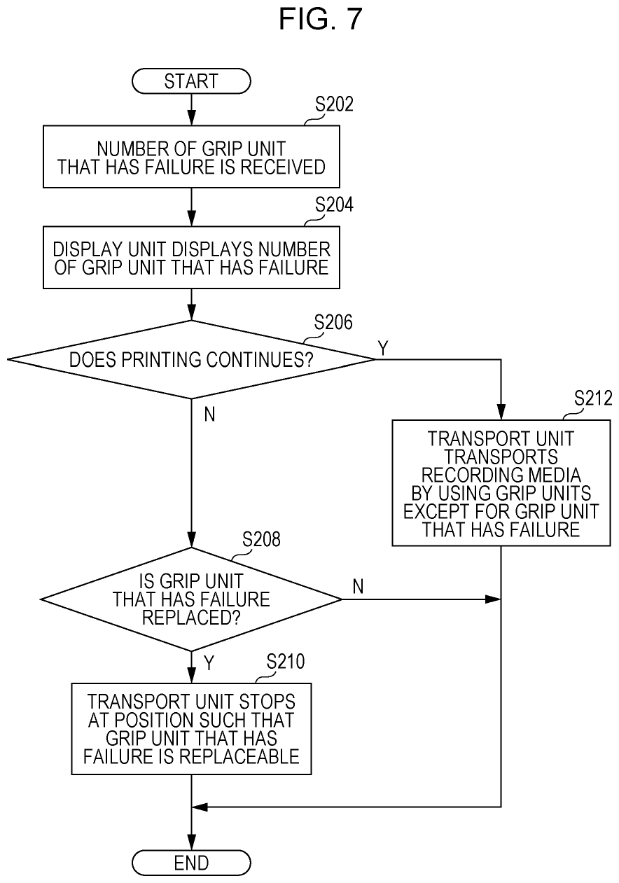

In the case where the grip unit 56 that transports the recording medium P on which the image is distorted is identified, as illustrated in FIG. 7, the user instructs the CPU 19A to perform the subsequent procedure for dealing with failure.

Procedure for Dealing with Failure

At a step S202, the CPU 19A receives the input of the number of the grip unit 56 that has failure. In the example described above, the user determines that the second grip unit 56B has failure and accordingly inputs “2” that is the number of the grip unit 56 into the input unit 62. The CPU 19A receives the determination that the second grip unit 56B has failure. The CPU 19A proceeds to a step S204.

Subsequently, at the step S204, the CPU 19A causes the display unit 60 to display the number of the grip unit 56 that has failure and causes the users of the image forming apparatus 10 including the user who inputs the number of the grip unit 56 and the operator to recognize the failure of the grip unit 56. The CPU 19A proceeds to a step S206.

Subsequently, at the step S206, the CPU 19A determines whether printing continues. More specifically, the CPU 19A determines whether a print job for forming another image is received. The determination may be made in accordance with a predetermined setting. The print job may be received as the input of an instruction from the user. In the case where the negative determination is made at the step S206, the CPU 19A proceeds to a step S208. In the case where the positive determination is made at the step S206, the CPU 19A proceeds to a step S212.

In the case where the CPU 19A proceeds to the step S208, the CPU 19A receives an instruction for replacing the grip unit 56 that has failure. In the case where the instruction for replacing the grip unit 56 that has failure is received, the CPU 19A makes the positive determination and proceeds to a step S210. In the case where the instruction for replacing the grip unit 56 that has failure is not received (including the case where an instruction for replacing no grip unit is received), the CPU 19A makes the negative determination and ends the flow of processing.

In the case where the CPU 19A proceeds to the step S210, the CPU 19A prohibits the reception of the print job for forming the other image. At the step S210, the CPU 19A causes the first transport unit 50a to stop at a position such that the grip unit 56 that has failure is replaceable. More specifically, the CPU 19A causes the chains 51 of the first transport unit 50a to rotate such that the operator is able to replace the second grip unit 56B that has failure and that is accepted at the step S202 and prompts the operator to replace the second grip unit 56B. In other words, at the step S210, the CPU 19A receives an instruction for replacing the specified second grip unit 56B. In the case where the instruction for replacing the specified second grip unit 56B is received, the CPU 19A causes the chains 51 to stop at positions such that the specific grip unit 56 is replaceable. The CPU 19A ends the flow of processing.

In the case where the CPU 19A proceeds to the step S212, the CPU 19A permits the reception of the print job for forming the other image. At the step S212, the CPU 19A causes the first transport unit 50a to transport the recording media P by using the grip units 56 except for the grip unit 56 that has failure and consequently performs the print job for forming the other image. In the example described above, the CPU 19A causes the recording media P to be transported by using five grip units 56 except for the second grip unit 56B and consequently performs the print job. In other words, at the step S212, the CPU 19A receives an instruction for excluding the specified second grip unit 56B. In the case where the subsequent print job is received, the CPU 19A causes the recording media P to be transported by using the other grip units 56 except for the second grip unit 56B for which the instruction for excluding is received. The CPU 19A ends the flow of processing.

According to the present exemplary embodiment, at the step S204, the step S210, or the step S212, the CPU 19A may cause the display unit 60 to display, for example, a sentence for prompting the replacement of the grip unit 56 that has failure.

The image forming apparatus 10 according to the present exemplary embodiment takes actions described below.

### Actions

As for the image forming apparatus 10 according to the present exemplary embodiment, the CPU 19A causes the image forming unit 20 to start image formation on the first recording medium P that is gripped by the first grip unit 56A among the multiple grip units 56 in the association mode.

As for the image forming apparatus 10 according to the present exemplary embodiment, the CPU 19A adds the identification information 70 for identifying the multiple grip units 56 into the recording media P on which the image forming unit 20 forms the images. As for the image forming apparatus 10 according to the present exemplary embodiment, the recording media P into which the identification information 70 is added are transported to the multiple grip units 56 that are associated with the identification information 70.

As for the image forming apparatus 10 according to the present exemplary embodiment, the CPU 19A causes the recording media P to be transported by using the other grip units 56 except for the specified grip unit 56 in the case where the instruction for excluding the specified grip unit 56 is received. In this way, the image forming apparatus 10 according to the present exemplary embodiment receives the print job even when the instruction for excluding the specified grip unit 56 is received and may continue the image formation.

As for the image forming apparatus 10 according to the present exemplary embodiment, the CPU 19A causes the chains 51 to stop at the positions such that the specific grip unit 56 is replaceable in the case where the instruction for replacing the specific grip unit 56 is received. Consequently, as for the image forming apparatus 10 according to the present exemplary embodiment, the specified grip unit 56 is easier to replace in the case where the instruction for replacing the specific grip unit 56 is received than the case where the positions at which the grip units 56 are stopped are not determined, and the chains 51 are stopped.

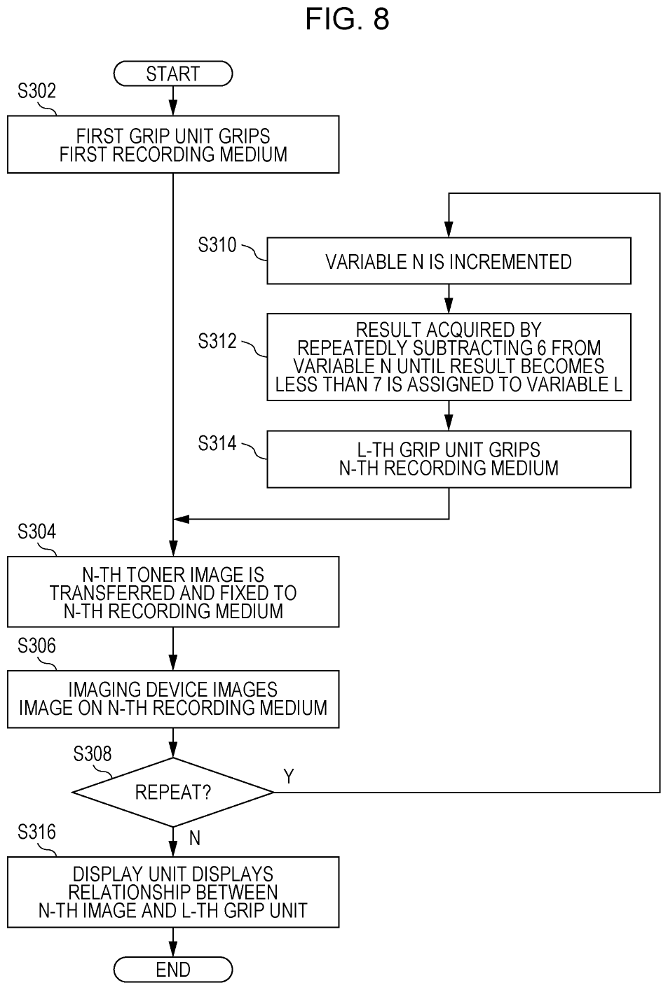

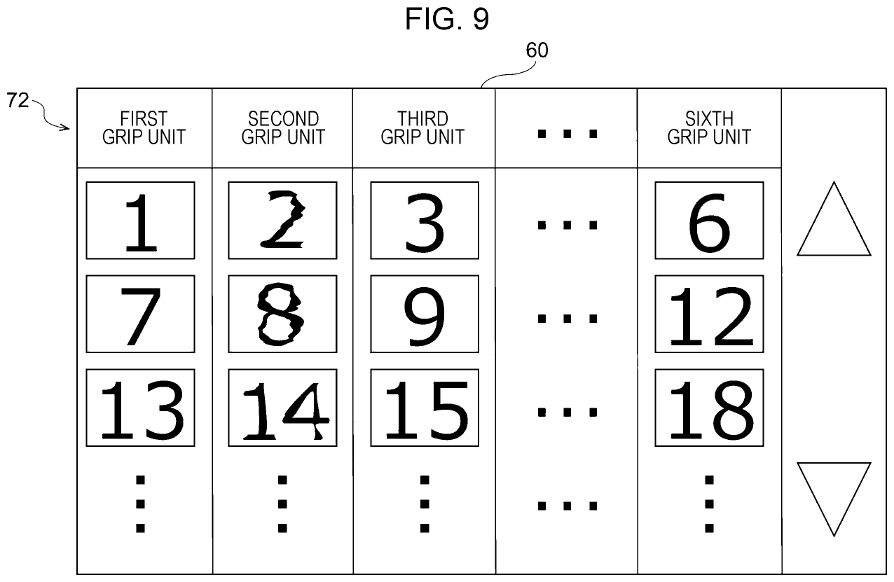

A first modification to the present exemplary embodiment will be described with reference to FIG. 8 and FIG. 9 appropriately. The structure of an image forming apparatus 10 according to the first modification is the same as the structure according to the first exemplary embodiment.

### First Modification

### Association Mode

In the association mode according to the present modification, the CPU 19A performs a flow of processing illustrated in FIG. 8. According to the present modification, the toner images that are formed do not contain the identification information 70 unlike the first exemplary embodiment.

At a step S302, the CPU 19A causes the first grip unit 56A to grip the first recording medium P. The CPU 19A prepares the variable N and the variable L in the RAM 19B. The variable N and the variable L are integer variables. The CPU 19A assigns 1 to the variable N and the variable L and initializes the variable N. The CPU 19A proceeds to a step S304.

Subsequently, at the step S304, the CPU 19A causes the image forming unit 20 to form the N-th image that corresponds to the value of the variable N. The N-th image is transferred to the recording medium P that corresponds to the value of the variable N at the time of the step S304. For example, in the case where the variable Nis 1, the CPU 19A causes the first image to be formed and causes the first image to be transferred to the first recording medium P. For example, in the case where the variable N is 2, the CPU 19A causes the second image to be formed and causes the second image to be transferred to the second recording medium P. For example, in the case where the variable N is 6, the CPU 19A causes the sixth image to be formed and to be transferred to the sixth recording medium P. For example, in the case where the variable N is 7, the CPU 19A causes the seventh image to be formed and to be transferred to the seventh recording medium P. For example, in the case where the variable N is 8, the CPU 19A causes the eighth image to be formed and to be transferred to the eighth recording medium P.

According to the present exemplary embodiment, the recording medium P to which the N-th image is transferred and to which the toner image is fixed by the fixing unit 40 is discharged via the discharge portion 16 of the image forming apparatus 10. The CPU proceeds to a step S306.

Subsequently, the step S306, the CPU 19A causes the imaging device 92 to image the N-th recording medium P to which the toner image is fixed and causes the RAM 19B to store imaging data. The CPU 19A causes the RAM 19B to store a relationship regarding the grip unit 56 that transports the N-th recording medium P. The CPU 19A proceeds to a step S308.

Subsequently, at the step S308, the CPU 19A compares the value of N with a predetermined value. In the case where the value of N is smaller than the predetermined value, at the step S308, the positive determination is made, and the CPU 19A proceeds to a step S310. In the case where the value of N is larger than the predetermined value, at the step S308, the negative determination is made, and the CPU 19A proceeds to a step S316.

Subsequently, at the step S310, the CPU 19A increments the variable N (increases the value of the variable N by 1). The CPU 19A proceeds to a step S312.

Subsequently, at the step S312, the CPU 19A assigns the value of the result acquired by repeatedly subtracting 6 from the value of the variable N until the result becomes less than 7 to the variable L. For example, in the case where the variable N is 1, 1 is assigned to the variable L. In the case where the variable N is 6, 6 is assigned to the variable L. In the case where the variable N is 8, 2 acquired by subtracting 6 from 8 is assigned to the variable L. The CPU 19A proceeds to a step S314.

Subsequently, at the step S314, the CPU 19A causes the grip unit 56 that corresponds to the value of the variable L to grip the N-th recording medium P that is transported from the container units 12. For example, in the case where the variable N is 2, the CPU 19A causes the second grip unit 56B to grip the second recording medium P. For example, in the case where the variable N is 6, the CPU 19A causes the sixth grip unit 56F to grip the sixth recording medium P. For example, in the case where the variable N is 7, the CPU 19A causes the first grip unit 56A to grip the seventh recording medium P. In the case where the variable N is 8, the CPU 19A causes the second grip unit 56B to grip the eighth recording medium P. The CPU 19A proceeds to the step S304.

At the step S316, the CPU 19A causes the display unit 60 to display relationships, stored in the RAM 19B, between an N-kinds of images ranging from the first image to the N-th image and the grip units 56 that transport the recording media P on which the images are formed as illustrated in FIG. 6. The CPU 19A ends the procedure for association.

According to the present modification, as illustrated in FIG. 9, the toner images that are fixed to the recording media P and the grip units 56 that transport the recording media P are displayed on the display unit 60. The display unit 60 displays identification information 72 according to the present modification that represents the grip units 56 that transport the recording media P. In other words, the CPU 19A associates the images that are fixed to the recording media P that are transported by the multiple grip units 56 with the identification information 72 for identifying the grip units 56 and causes the display unit 60 to display these. Leaders (symbols “ . . . ”) in FIG. 9 represent omission.

The user checks whether the N-th images on the recording media P are distorted while visually comparing the imaging data of the recording media P and the identification information 72 that are displayed on the display unit 60. More specifically, the user visually compares the imaging data of the recording media P and the images that are displayed on the display unit 60 as illustrated in FIG. 9 and checks whether the toner images are distorted. For example, according to the present exemplary embodiment, as illustrated in FIG. 9, the toner images (the second image, the eighth image, and the fourteenth image) of “2”, “8”, and “14” are fixed so as to be distorted, and accordingly, the user determines that the second grip unit 56B that transports the recording media P have failure. The user thus checks the toner images that are displayed on the display unit 60 and the identification information 72 and consequently identifies the grip unit 56 that has failure.

The procedure for dealing with failure according to the present modification is the same as that according to the first exemplary embodiment. The present modification takes actions described below.

### Actions

As for the image forming apparatus 10 according to the present exemplary embodiment, the CPU 19A associates the images that are formed on the recording media P that are transported by the multiple grip units 56 with the identification information 72 for identifying the grip units 56 and causes the display unit 60 to display these. In this way, in the case where any one of the multiple grip units 56 is the grip unit 56 that has failure, the user may identify the grip unit 56 that has failure.

### Other Modifications

In the above description, as illustrated in FIG. 6, the second grip unit 56B has failure, and the second, the eighth, and the fourteenth images are distorted. In the above description, the user checks the toner images and the identification information 70 and identifies the grip unit 56 that has failure. A technique according to the present disclosure, however, is not limited thereto. For example, the user may determine that every sixth image from the second image is distorted, based on the toner images on the second, the eighth, and the fourteenth recording media P that are discharged and may determine that the second grip unit 56B has failure.

In the description according to the first exemplary embodiment, serial numbers starting from 1 are added as the identification information 70 into the toner images. The present disclosure, however, is not limited thereto. That is, the identification information 70 is not limited to a numeral but may be, for example, a symbol, provided that the identification information 70 is enough for the user to recognize the recording media P that are transported by the multiple grip units 56.

In the description according to the first modification, the toner images are formed so as not to contain the identification information 70. A technique according to the present modification, however, is not limited thereto. That is, toner images that contain the identification information 70 may be formed on the recording media P also according to the first modification. In other words, the display unit 60 may display both of the identification information 70 and the identification information 72.

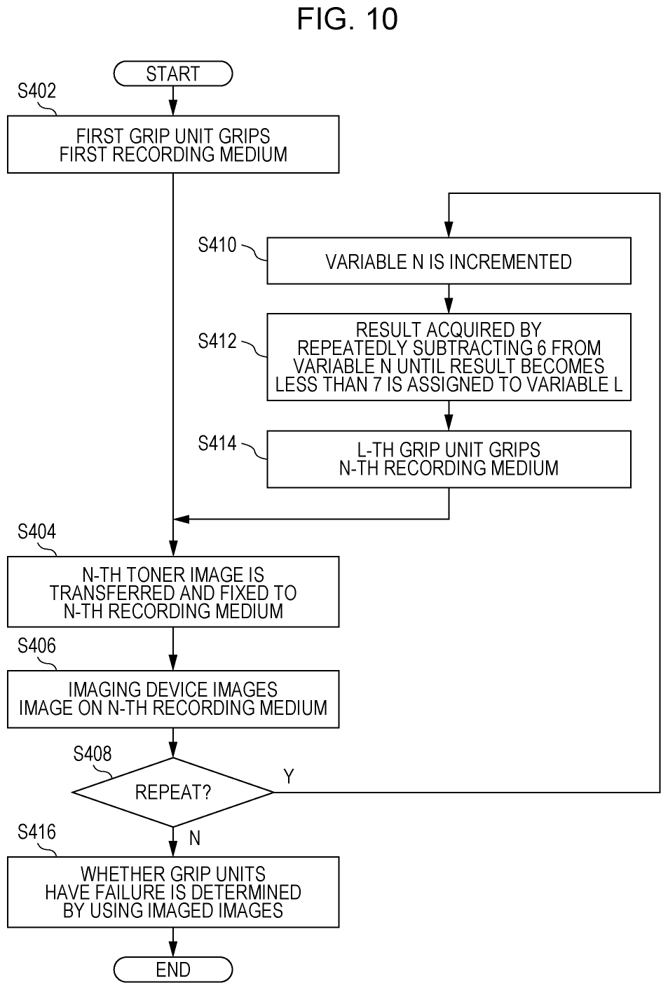

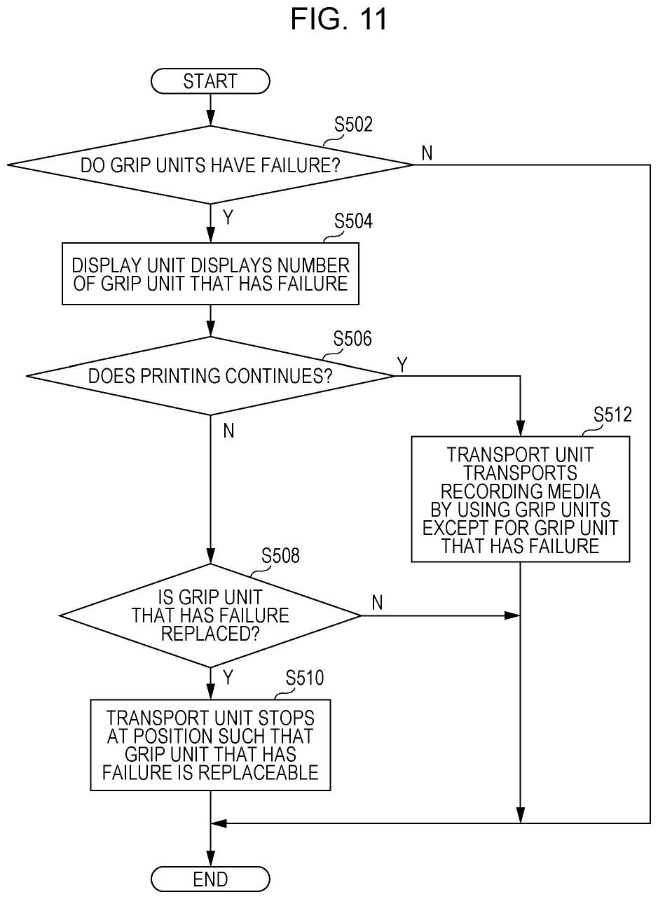

A second exemplary embodiment of the present disclosure will be described with reference to FIG. 10 and FIG. 11 appropriately. The structure of an image forming apparatus 10 according to the second exemplary embodiment is the same as that according to the first exemplary embodiment.

### Second Exemplary Embodiment

### Association Mode

The operation of the CPU 19A of the controller 19 in the association mode will now be described with reference to FIG. 10 and FIG. 11 appropriately. In the association mode according to the present exemplary embodiment, the CPU 19A performs the procedure for association and the procedure for dealing with failure as in the association mode according to the first exemplary embodiment. In the association mode, the recording media P the number of which is larger than the number (six according to the present exemplary embodiment) of the grip units 56 are prepared in the container units 12 in advance. The CPU 19A performs a flow of processing illustrated in FIG. 10. According to the present exemplary embodiment, the toner images are formed so as not to contain the identification information 70 unlike the first exemplary embodiment.

The CPU 19A causes the first grip unit 56A to grip the first recording medium P. At a step 402, the CPU 19A prepares the variable N and the variable L in the RAM 19B. The variable N and the variable L are integer variables. The CPU 19A assigns 1 to the variable N and the variable L and initializes the variable N. The CPU 19A proceeds to a step S404.

Subsequently, at the step S404, the CPU 19A causes the image forming unit 20 to form the toner image that corresponds to the value of the variable N. The toner image is transferred to the recording medium P that corresponds to the value of the variable N at the time of the step S404. For example, in the case where the variable N is 1, the CPU 19A causes the first image to be formed and causes the first image to be transferred to the first recording medium P. For example, in the case where the variable N is 2, the CPU 19A causes the second image to be formed and causes the second image to be transferred to the second recording medium P. For example, in the case where the variable N is 6, the CPU 19A causes the sixth image to be formed and to be transferred to the sixth recording medium P. For example, in the case where the variable N is 7, the CPU 19A causes the seventh image to be formed and to be transferred to the seventh recording medium P. For example, in the case where the variable N is 8, the CPU 19A causes the eighth image to be formed and to be transferred to the eighth recording medium P.

Subsequently, at a step S406, the CPU 19A causes the imaging device 92 to image the recording medium P in which the toner image that corresponds to the value of the variable N is formed and causes the RAM 19B to store the image of the recording medium P that is imaged. According to the present exemplary embodiment, the RAM 19B sequentially stores data as illustrated in FIG. 6. The recording medium P that is imaged by the imaging device 92 is discharged via the discharge portion 16 of the image forming apparatus 10. The CPU 19A proceeds to a step S408.

Subsequently, at the step S408, the CPU 19A compares the value of N and a predetermined value. In the case where the value of N is smaller than the predetermined value, at the step S408, the positive determination is made, and the CPU 19A proceeds to a step S410. In the case where the value of N is larger than the predetermined value, at the step S408, the negative determination is made, and the CPU 19A proceeds to a step S416.

Subsequently, at the step S410, the CPU 19A increments the variable N (increases the value of the variable N by 1). The CPU 19A proceeds to a step S412.

Subsequently, at the step S412, the CPU 19A assigns the value of the result acquired by repeatedly subtracting 6 from the value of the variable N until the result becomes less than 7 to the variable L. For example, in the case where the variable N is 1, 1 is assigned to the variable L. In the case where the variable N is 6, 6 is assigned to the variable L. In the case where the variable N is 8, 2 acquired by subtracting 6 from 8 is assigned to the variable L. The CPU 19A proceeds to a step S414.

Subsequently, at the step S414, the CPU 19A causes the grip unit 56 that corresponds to the value of the variable L to grip the N-th recording medium P that is transported from the container units 12. For example, in the case where the variable N is 2, the CPU 19A causes the second grip unit 56B to grip the second recording medium P. For example, in the case where the variable N is 6, the CPU 19A causes the sixth grip unit 56F to grip the sixth recording medium P. For example, in the case where the variable N is 7, the CPU 19A causes the first grip unit 56A to grip the seventh recording medium P. In the case where the variable N is 8, the CPU 19A causes the second grip unit 56B to grip the eighth recording medium P. The CPU 19A proceeds to the step S404.

At the step S416, the CPU 19A compares an N-kinds of imaging data that is stored in the RAM 19B ranging from the first image to the N-th image that are imaged by the imaging device 92 and determines whether the grip units 56 have failure. According to the present exemplary embodiment, in the case where the toner images on the second recording medium P, the eighth recording medium P, and the fourteenth recording medium P are fixed so as to be distorted as illustrated in FIG. 6, the CPU 19A determines that the second grip unit 56B that transports the recording media P has failure. In the case where the CPU 19A thus determines that toner images that are imaged by the imaging device 92 are distorted, the grip unit 56 that transports the recording media P on which the images are formed is checked, and consequently, the grip unit 56 that has failure is identified. The CPU 19A causes the RAM 19B to store information that represents that the grip unit 56 has failure.

Subsequently, as illustrated in FIG. 11, the CPU 19A according to the present exemplary embodiment performs the subsequent procedure for dealing with failure.

Procedure for Dealing with Failure

At a step S502, the CPU 19A checks whether the grip units 56 have failure. More specifically, whether information about the grip unit 56 that is identified as one having failure is stored in the RAM 19B is checked. If it is determined that the information about the grip unit 56 that has failure is stored in the RAM 19B, the CPU 19A makes the positive determination at the step S502 and proceeds to a step S504. If it is determined that the information about the grip unit 56 that has failure is not stored in the RAM 19B, the CPU 19A makes the negative determination at the step S502 and ends the flow of processing.

Subsequently, at the step S504, the CPU 19A causes the display unit 60 to display the number of the grip unit 56 that has failure. In the example described above, the CPU 19A determines that the second grip unit 56B has failure, and accordingly, the display unit 60 displays “2” that is the number of the grip unit 56. In other words, in the case where the CPU 19A identifies the grip unit 56 that has failure, the display unit 60 displays the identification information 72 about the grip unit 56 that has failure. The CPU 19A proceeds to a step S506.

Subsequently, at the step S506, the CPU 19A determines whether printing continues. More specifically, the CPU 19A determines whether the print job for forming another image is received. The determination may be made in accordance with a predetermined setting. The print job may be received as the input of an instruction from the user. In the case where the negative determination is made at the step S506, the CPU 19A proceeds to a step S508. In the case where the positive determination is made at the step S506, the CPU 19A proceeds to a step S512.

In the case where the CPU 19A proceeds to the step S508, the CPU 19A receives the instruction for replacing the grip unit 56 that has failure. In the case where the instruction for replacing the grip unit 56 that has failure is received, the CPU 19A makes the positive determination and proceeds to a step S510. In the case where the instruction for replacing the grip unit 56 that has failure is not received (including the case where the instruction for replacing no grip unit is received), the CPU 19A makes the negative determination and ends the flow of processing.

In the case where the CPU 19A proceeds to the step S510, the CPU 19A prohibits the reception of the print job for forming the other image. At the step S510, the CPU 19A causes the first transport unit 50a to stop at the position such that the grip unit 56 that has failure is replaceable. More specifically, the CPU 19A causes the chains 51 of the first transport unit 50a to rotate such that the operator is able to replace the second grip unit 56B that has failure and that is accepted at the step S502. In other words, in the case where the grip unit 56 that has failure is recognized, the CPU 19A causes the chains 51 to stop at the positions such that the grip unit 56 that has failure is replaceable. The CPU 19A ends the flow of processing.

In the case where the CPU 19A proceeds to the step S512, the CPU 19A permits the reception of the print job for forming the other image. At the step S512, the CPU 19A causes the first transport unit 50a to transport the recording media P by using the grip units 56 except for the grip unit 56 that has failure and consequently performs the print job for forming the other image. In the example described above, the CPU 19A causes the recording media P to be transported by using the five grip units 56 except for the second grip unit 56B and consequently performs the print job. In other words, in the case where the grip unit 56 that has failure is identified, the CPU 19A causes the recording media P to be transported by using the other grip units 56 except for the grip unit 56 that has failure. The CPU 19A ends the flow of processing.

According to the present exemplary embodiment, the CPU 19A may cause the display unit 60 to display, for example, a sentence for prompting the replacement of the grip unit 56 that has failure at the step S504, the step S510, or the step S512.

The image forming apparatus 10 according to the present exemplary embodiment takes actions described below.

### Actions

As for the image forming apparatus 10 according to the present exemplary embodiment, the CPU 19A identifies the grip unit 56 that has failure, based on the association information about the multiple grip units 56 and the recording media P and the result of measurement of the measurement device. In this way, the image forming apparatus 10 according to the present exemplary embodiment may automatically identify the grip unit 56 that has failure.

As for the image forming apparatus 10 according to the present exemplary embodiment, in the case where the grip unit 56 that has failure is identified, the CPU 19A causes the display unit 60 to display the identification information 72 about the grip unit 56 that has failure. In this way, the image forming apparatus 10 according to the present exemplary embodiment may enable the user to recognize the failure of the grip unit 56 that is displayed on the display unit 60 in the case where the grip unit 56 that has failure is identified.

As for the image forming apparatus 10 according to the present exemplary embodiment, in the case where the grip unit 56 that has failure is identified, the CPU 19A causes the recording media P to be transported by using the other grip units 56 except for the grip unit 56 that has failure. In this way, the image forming apparatus 10 according to the present exemplary embodiment may enable the image formation to continue also in the case where the grip unit 56 that has failure is recognized.

As for the image forming apparatus 10 according to the present exemplary embodiment, in the case where the grip unit 56 that has failure is recognized, the CPU 19A causes the chains 51 to stop at the positions such that the grip unit 56 that has failure is replaceable. This enables the image forming apparatus 10 according to the present exemplary embodiment to facilitate an operation for replacing the grip unit 56 that has failure in the case where the grip unit 56 that has failure is identified unlike the case where the positions at which the grip units 56 are stopped are not determined, and the chains 51 are stopped.

### Other Modifications

In the above description, at the step S504, the CPU 19A causes the display unit 60 to display the grip unit 56 that has failure in the case where the grip unit 56 that has failure is identified. The technique according to the present disclosure, however, is not limited thereto. For example, the display unit 60 may not display the grip unit 56 that has failure, but the CPU 19A may proceed to the step S506.

### Other Exemplary Embodiments

In the above exemplary embodiments, the CPU 19A causes different toner images to be formed on the recording media P. The technique according to the present disclosure, however, is not limited thereto. That is, all of the grip units 56 may transport the same toner image. Also in this case, the user checks whether the toner image is distorted on every number of the recording medium P that is the same as the number of the grip units 56 from the N-th recording medium P that firstly has failure among the recording media P that are discharged and may determine which the grip unit 56 has failure in this way.

In the above description, the image forming apparatus 10 includes the imaging device 92. The technique according to the present disclosure, however, is not limited thereto. For example, in the case where the user forms association in the association mode according to the first exemplary embodiment, the image forming apparatus 10 may not include the imaging device 92.

In the above description, the image forming unit 20 forms the toner images on the recording media P such as paper in accordance with an instruction from the CPU 19A. The technique according to the present disclosure, however, is not limited thereto. That is, an image formation system may be any system, provided that the image forming apparatus transports the recording media P by using the multiple grip units 56 as in the above description. For example, the image formation system may be an electrophotographic system, an ink-jet system, or an offset printing system.

These modifications take the same actions as in the above description.

The exemplary embodiments of the present disclosure are described above with reference to the drawings. It is clear for a person skilled in the art to which the present disclosure belongs to arrive at various modifications or applications within the range of the technical idea described in claims, and it is understood that these are included in the technical scope of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An image forming system includes a transport device including a loop member that turns and that includes a plurality of grip units, the transport device transporting a medium that is gripped by the plurality of grip units as the loop member turns; a formation device that forms an image on the medium that is transported by the transport device; and a processor configured to: cause the formation device to start image formation on a medium that is gripped by a specific grip unit of the plurality of grip units in an association mode.

(((2)))

The image forming system described in (((1))) further includes a display unit in which the processor is configured to: associate the image that is formed on the medium that is transported by the plurality of grip units with identification information for identifying the plurality of grip units; and cause the display unit to display the image and the identification information.

(((3)))

As for the image forming system described in (((1))) or (((2))), the processor is configured to: add identification information for identifying the plurality of grip units into the medium on which the formation device forms the image; and cause the plurality of grip units that is associated with the identification information to transport the medium into which the identification information is added.

(((4)))

As for the image forming system described in (((2))) or (((3))), the processor is configured to cause the medium to be transported by using another grip unit other than a specified grip unit of the plurality of grip units in a case where an instruction for excluding the specified grip unit of the plurality of grip units is received.

(((5)))

As for the image forming system described in (((2))) or (((3))), the processor is configured to cause the loop member to stop at a position such that a specific grip unit of the plurality of grip units is replaceable in a case where an instruction for replacing the specific grip unit of the plurality of grip units is received.

(((6)))

The image forming system described in any one of (((1))) to (((5))) further includes a measurement device that is disposed downstream of the transport device on a transport path for the medium and that measures the medium on which the image is formed in which the processor is configured to identify a grip unit that has failure among the plurality of grip units, based on association information about the plurality of grip units and the medium and a result of measurement of the measurement device.

(((7)))

The image forming system described in (((6))) further includes a display unit in which the processor is configured to cause the display unit to display the identification information about the grip unit that has failure among the plurality of grip units in a case where the grip unit that has failure among the plurality of grip units is identified.

(((8)))

As for the image forming system described in (((6))) or (((7))), the processor is configured to cause the medium to be transported by using another grip unit other than the grip unit that has failure among the plurality of grip units in a case where the grip unit that has failure among the plurality of grip units is identified.

(((9))

As for the image forming system described in (((6))) or (((7))), the processor is configured to cause the loop member to stop at a position such that the grip unit that has failure among the plurality of grip units is replaceable in a case where the grip unit that has failure among the plurality of grip units is recognized.

What is claimed is:

1. An image forming system comprising:
a transport device including a loop member that turns and that includes a plurality of grip units, the transport device transporting a medium that is gripped by the plurality of grip units as the loop member turns;
a formation device that forms an image on the medium that is transported by the transport device; and
a processor configured to:
cause the formation device to start image formation on a medium that is gripped by a specific grip unit of the plurality of grip units in an association mode.

2. The image forming system according to claim 1, further comprising;
a display unit,
wherein the processor is configured to:
associate the image that is formed on the medium that is transported by the plurality of grip units with identification information for identifying the plurality of grip units; and
cause the display unit to display the image and the identification information.

3. The image forming system according to claim 1,
wherein the processor is configured to:
add identification information for identifying the plurality of grip units into the medium on which the formation device forms the image; and
cause the plurality of grip units that is associated with the identification information to transport the medium into which the identification information is added.

4. The image forming system according to claim 2,
wherein the processor is configured to cause the medium to be transported by using another grip unit other than a specified grip unit of the plurality of grip units in a case where an instruction for excluding the specified grip unit of the plurality of grip units is received.

5. The image forming system according to claim 3,
wherein the processor is configured to cause the medium to be transported by using another grip unit other than a specified grip unit of the plurality of grip units in a case where an instruction for excluding the specified grip unit of the plurality of grip units is received.

6. The image forming system according to claim 2,
wherein the processor is configured to cause the loop member to stop at a position such that a specific grip unit of the plurality of grip units is replaceable in a case where an instruction for replacing the specific grip unit of the plurality of grip units is received.

7. The image forming system according to claim 3,
wherein the processor is configured to cause the loop member to stop at a position such that a specific grip unit of the plurality of grip units is replaceable in a case where an instruction for replacing the specific grip unit of the plurality of grip units is received.

8. The image forming system according to claim 1, further comprising:
a measurement device that is disposed downstream of the transport device on a transport path for the medium and that measures the medium on which the image is formed,
wherein the processor is configured to identify a grip unit that has failure among the plurality of grip units, based on association information about the plurality of grip units and the medium and a result of measurement of the measurement device.

9. The image forming system according to claim 8, further comprising:
a display unit,
wherein the processor is configured to cause the display unit to display identification information about the grip unit that has failure among the plurality of grip units in a case where the grip unit that has failure among the plurality of grip units is identified.

10. The image forming system according to claim 8,
wherein the processor is configured to cause the medium to be transported by using another grip unit other than the grip unit that has failure among the plurality of grip units in a case where the grip unit that has failure among the plurality of grip units is identified.

11. The image forming system according to claim 9,
wherein the processor is configured to cause the medium to be transported by using another grip unit other than the grip unit that has failure among the plurality of grip units in a case where the grip unit that has failure among the plurality of grip units is identified.

12. The image forming system according to claim 8,
wherein the processor is configured to cause the loop member to stop at a position such that the grip unit that has failure among the plurality of grip units is replaceable in a case where the grip unit that has failure among the plurality of grip units is recognized.

13. The image forming system according to claim 9,
wherein the processor is configured to cause the loop member to stop at a position such that the grip unit that has failure among the plurality of grip units is replaceable in a case where the grip unit that has failure among the plurality of grip units is recognized.

14. An image forming system comprising:
means for transporting a medium that is gripped by a plurality of grip units as a loop member turns;
means for forming an image on the medium that is transported by the means for transporting; and
means for causing the means for forming to start image formation on a medium that is gripped by a specific grip unit of the plurality of grip units in an association mode.
